(19) United States
(12) Patent Application Publication
(10) Pub. No.: US 2002/0169798 A1
(43) Pub. Date: Nov. 14, 2002

(54) Contents inspecting system and contents inspecting method used therefor

(76) Inventor: Tomoo Ooishi, Kakegawa-shi (JP)

Correspondence Address: DICKSTEIN SHAPIRO MORIN & OSHINSKY LLP, 2101 L STREET NW, WASHINGTON, DC, 20037-1526, US

(21) Appl. No.: 10/040,382

(22) Filed: Jan. 9, 2002

(30) Foreign Application Priority Data
Jan. 10, 2001 (JP) JP2001-002000

(51) Int. Cl. G06F 17/00

(52) U.S. Cl. 707/501.1

(57) ABSTRACT

When an internet access operation is conducted, a browser 2 demands acquisition or an HTML document from an HTTP server 11. When receiving the demand, the HTTP server 11 reads out contents 14 and transmits them to a terminal apparatus. The browser 2 Interprets the received contents 14, and if an exclusive tag for explaining an outline of the contents 14 exists, the browser sends an acquisition demand of a voice data 15 for explaining the outline of the contents to the HTTP server 11. When receiving the acquisition demand, the HTTP server 11 reads out the specified voice data 15, and transmits it to the browser 2. On a side of the browser 2, the voice data 15 is stored in a memory 6, and a regeneration demand of the downloaded voice data 15 is issued. A voice control section 9 regenerates the voice data 15 and outputs it from a speaker 10.

### BACKGROUND OF THE INVENTION

The present invention relates to a contents inspecting system and a contents inspecting method used therefore, and especially, to Inspection of contents in an internet terminal apparatus such as a PC (personal computer).

Conventionally, in this kind of internet terminal apparatus, by operating browser software in a PC or the like, it is possible to inspect contents of a homepage accumulated in a server via an Internet.

Presently, other than the above-described PC, there are a television image receiving device and an exclusive terminal or the like for the Internet terminal apparatus, and however, in addition to these, it becomes possible to inspect the contents even in a small-sized instrument such as a mobile telephone terminal or the like.

However, in the conventional internet terminal apparatus, there are few contents explaining in their page that the contents which can be inspected are what contents, and there are many cases where it is not possible to inspect the contents smoothly, and especially, a user who is not familiar with an internet is puzzled.

Also, even though an outline of the contents is temporarily explained by letters, since in this case the explanation is made by the letters, the number of the letters increase and the contents become difficult to be understood.

Further, although it is possible to download binary contents of a music data or the like by means of the current browser software, that is not corresponding to downloading of the music data, which is for a purpose in smoothly conducting inspection of an internet.

### SUMMARY OF THE INVENTION

The objective of the present invention is to overcome the above-described task.

Furthermore, the objective of the present invention is to provide a contents inspecting system and a contents inspecting method used therefor capable of facilitating the understanding of an outline of the contents and smoothly inspecting the contents.

A contents inspecting system in accordance with the present invention is a contents inspecting system for inspecting contents accumulated in a server and consisting of at least HTML (hypertext markup language) data by means of a terminal apparatus, wherein

said server has storage means for storing contents in which a voice data for explaining an outline of said contents, and an exclusive tag for specifying said voice data are described, and

said terminal apparatus has determination means for determining whether or not said exclusive tag in the contents read from said server exists, means for downloading a voice data corresponding to said exclusive tag from said server when it is determined in said determination means that said exclusive tag exists, and means for regenerating and outputting said voice data in response to said exclusive tag during regeneration of said contents.

A contents inspecting method in accordance with the present invention is a contents inspecting method of inspecting contents accumulated in a server and consisting of at least HTML (hypertext markup language) data by means of a terminal apparatus, wherein

contents in which a voice data for explaining an outline of said contents, and an exclusive tag for specifying said voice data are described, are stored in said server, and

said terminal apparatus has steps of determining whether or not said exclusive tag in the contents read from said server exists, downloading a voice data corresponding to said exclusive tag from said server when it is determined that said exclusive tag exists, and regenerating and outputting said voice data in response to said exclusive tag during regeneration of said contents.

In other words, in the contents inspecting system of the present invention, by preparing the voice data for explaining the contents in the server, and specifying the voice data using the exclusive tag on the HTML (hypertext markup language), when a user has access to the contents using a browser functions the terminal interprets the exclusive tag, and automatically downloads and regenerates the voice data. Thereby, it becomes possible for the user to confirm the explanation of the contents by means of voice.

Also, only a part of voice, which depends on the contents, is downloaded from the server, and information for a wide use, such as other genre and updated date and hour, is loaded in the terminal in advance as a common voice data, and thereby, when the tag is interpreted, it becomes possible to regenerate fixed voice thereof.

### BRIEF DESCRIPTION OF THE DRAWING

This and other objects, features and advantages of the present invention will become more apparent upon a reading of the following detailed description and drawings, in which:

FIG. 1 is a block diagram showing an arrangement of an Internet inspecting system in accordance with one embodiment of the present invention;

FIG. 2 is a flowchart showing an operation of the internet inspecting system in accordance with one embodiment of the present invention;

FIG. 3 is a flowchart showing an operation of the internet inspecting system in accordance with one embodiment of the present invention;

FIG. 4 is a view showing an HTML data in which an exclusive tag example of a music data for explaining an outline of contents is described, in accordance with one embodiment of the present invention.

### DESCRIPTION OP THE EMBODIMENTS

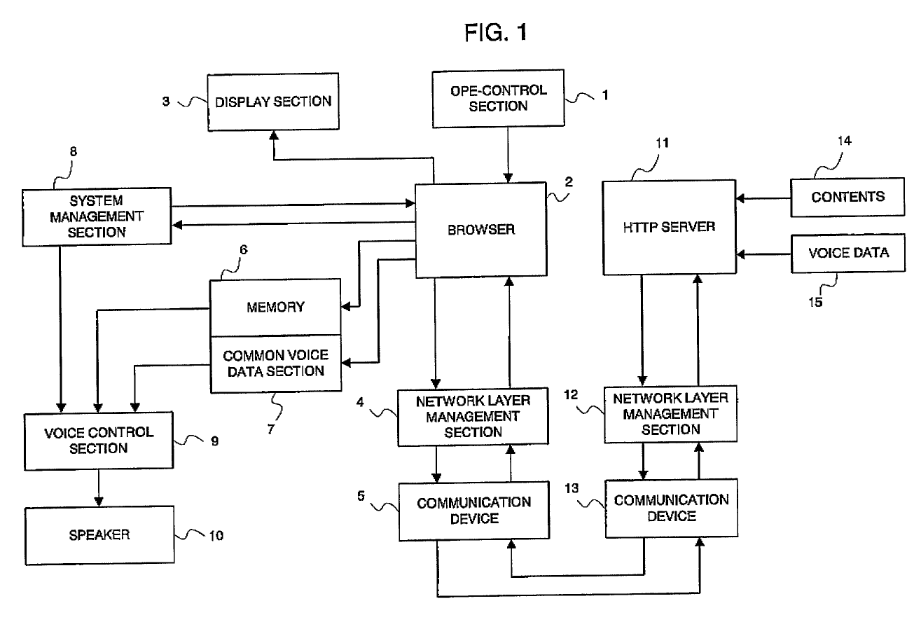

Next, one embodiment of the present invention will be explained referring to drawings. FIG. 1 is a block diagram showing an arrangement of an internet inspecting system in accordance with one embodiment of the present invention. In FIG. 1, the internet inspecting system in accordance with one embodiment of the present invention is constructed of an operation control section (referred to as an ope-control section, hereinafter) 1, a browser 2, a display section 3, network layer management sections 4 and 12, communication devices 5 and 13, a memory 6, a common voice data section 7, a system management section 8, a voice control section 9, a speaker 10, and an HTTP (hypertext transfer protocol) server 11.

Out of the above-described constitution elements, an internet terminal apparatus is constructed of the ope-control section 1, the browser 2, the display section 3, the network layer management section 4, the communication device 5, the memory 6, the common voice data section 7, the system management section 8, the voice control section 9 and the speaker 10, and if these constitution elements are included, the internet terminal apparatus can be a PC (personal computer), a television image receiving device, an exclusive terminal, a mobile telephone terminal or the like.

The ope-control section 1 is for conducting an operation of the internet terminal apparatus by a user. The browser 2 is consisting of software, and due to execution by a CPU (central processing unit) which is not shown in drawings, the browser interprets and processes contents made of an HTML or the like received from the HTTP server 11, and displays them on the display section 3.

The network layer management section 4 and the communication device 5 are subordinate layers when conducting communication of an HTTP between the browser 2 and the HTTP server 11. The memory 6 is for storing a voice data [ADPCM (Adaptive Differential Pulse Code Modulation) or the like] downloaded from the HTTP server 11, and in the common voice data section 7, a common voice data prepared in advance on a terminal side is accumulated.

The system management section 8 conducts intermediation of an operation of each section within the internet terminal apparatus, such as the browser 2, the voice control section 9 or the like. The voice control section 9 regenerates voice downloaded from the HTTP server 11 and common voice accumulated in the common voice data section 7, and outputs them from the speaker 10.

The HTTP server 11 is a device for distributing contents 14 made of HTML or the like and a voice data to the internet terminal apparatus, and the network layer management section 12 and the communication device 13 are subordinate layers of the HTTP server 11. The contents (HTML) 14 are placed on the HTTF server 11. and a voice data 15 is for explaining an outline of the contents 14.

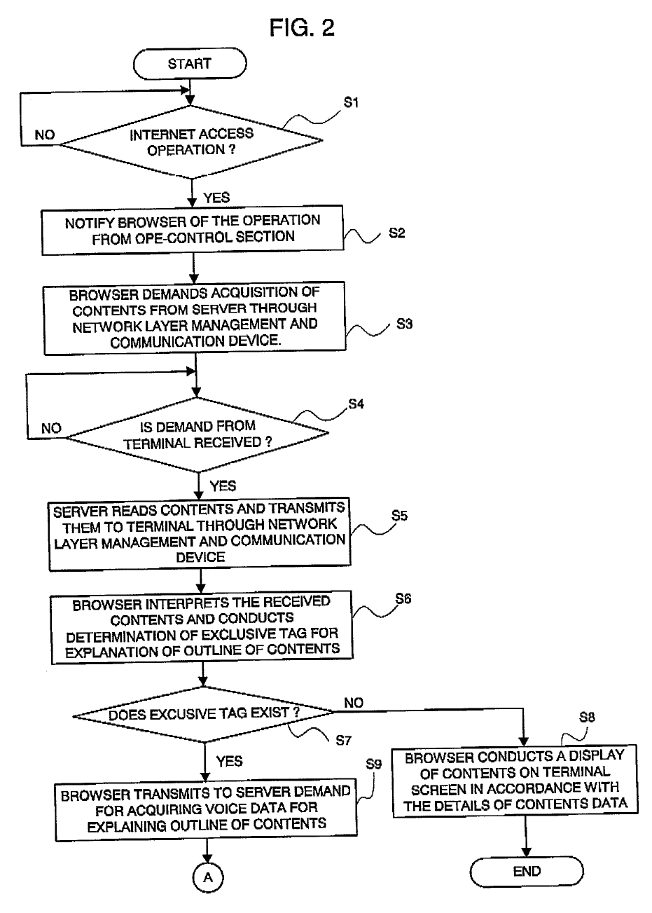

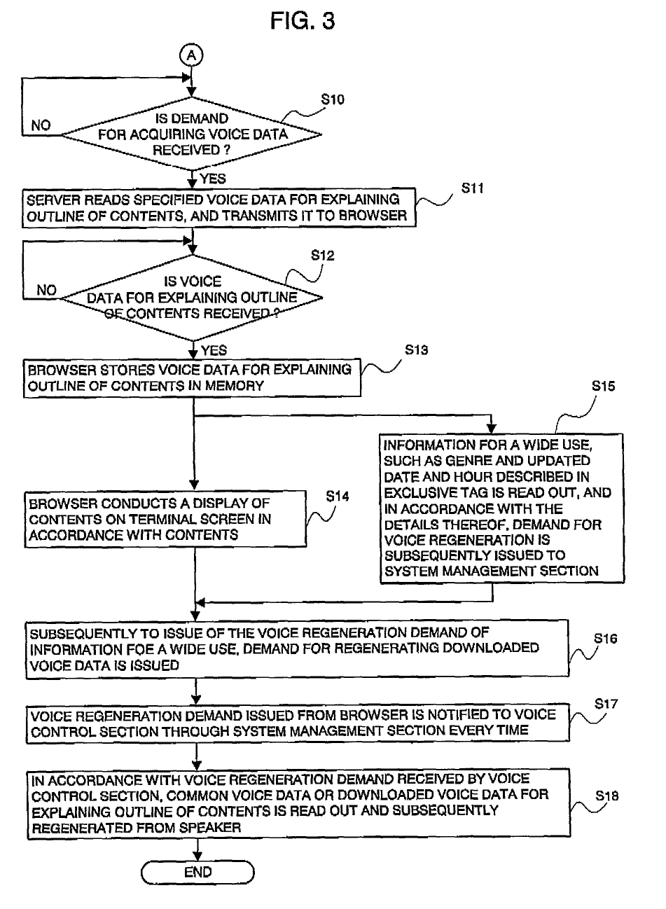

FIG. 2 and FIG. 3 are flowcharts showing an operation of the internet inspecting system in accordance with one embodiment of the present invention. Referring to these FIG. 1 to FIG. 3, the operation of the internet inspecting system in accordance with one embodiment of the present invention will be explained.

When a user operates the Internet terminal and conducts an internet access operation (Step S1 in FIG. 2), the operation is notified to the browser 2 through the ope-control section 1 (Step S2 in FIG. 2), and the browser 2 demands acquisition of an HTML document from the HTTP server 11 through the network layer management section 4 and the communication device 5 (Step S3 in FIG. 2).

In the HTTP server 11 when the demand from the internet terminal apparatus is received (Step S4 in FIG. 2), the contents (HTML data) 14 are read out, and are transmitted to the internet terminal apparatus through the network layer management section 12 and the communication device 13 (Step S5 in FIG. 2). Here, since an arrangement and an operation of subordinate layers of the network layer management sections 4 and 12 and the communication devices 5 and 13 are known, the explanation of the arrangement and operation will be omitted.

The browser 2 interprets the received contents (HTML data) 14, and conducts determination of the exclusive tag for explaining an outline of the contents 14 (Step S6 in FIG. 2), and if the exclusive tag does not exist (Step S7 in FIG. 2), the browser 2 conducts a display of the contents 14 on a terminal screen (the display section 3) in accordance with the details of the received contents 14 (Step S8 in FIG. 2).

If the exclusive tag exists (Step S7 in FIG. 2), the browser 2 sands the HTTP server 11 an acquisition demand of the voice data 15 for explaining an outline of the contents (Step S9 in FIG. 2). When receiving the acquisition demand of the voice data 15 for explaining the outline of the contents (Step S10 in FIG. 3), the HTTP server 11 reads out the specified voice data 15 for explaining the outline of the contents, and transmits it to the browser 2 (Step S11 in FIG. 3).

On a side of the browser 2, when the voice data 15 for explaining the outline of the contents is received (Step S12 in FIG. 3), the voice data 15 is stored in the memory 6 (Step S13 in FIG. 3). Successively, the browser 2 conducts a display of the contents 14 on the terminal screen (the display section 3) in accordance with the details of the HTML data (Step S14 in FIG. 3), and however, at the same time, the browser reads out Information for a wide use, such as a genre and updated date and hour described in the exclusive tag, and in accordance with the details thereof, subsequently issues a voice regeneration demand to the system management section 8 (Step S15 in FIG. 3).

Following the issue of the voice regeneration demand of the information for a wide use, the browser 2 issues a regeneration demand of the downloaded voice data 15 (Step S16 in FIG. 3). The voice regeneration demand issued from the browser 2 is notified to the voice control section 9 through the system management section 8 every time (Step S17 in FIG. 3).

In the voice control section 9, in accordance with the received voice regeneration demand, the common voice data or the downloaded voice data 15 for explaining the outline of the contents is read out from the common voice data section 7 and the memory 6, and is subsequently regenerated and output from the speaker 10 (Step S18 in FIG. 3). By means of the above operation, it becomes possible to acquire the voice data 15 for showing the outline of the contents 14 and regenerate the outline of the contents 14 by means of voice.

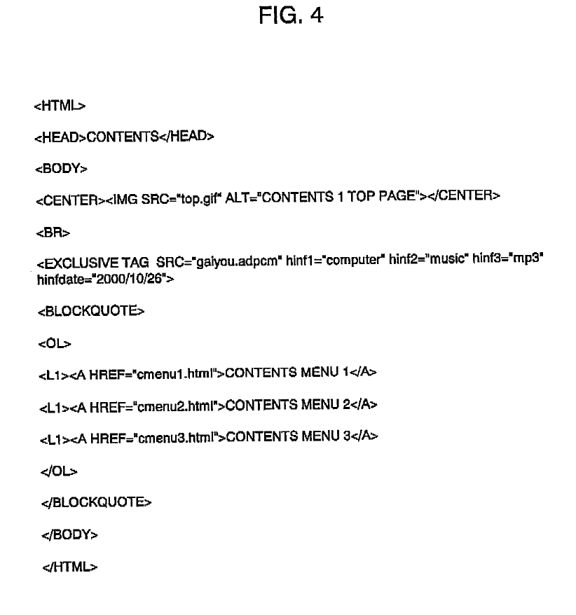

FIG. 4 is a view showing an HTML data in which an exclusive tag example of the voice data 15 for explaining the outline of the contents is described, in accordance with one embodiment of the present Invention. In FIG. 4, a part interposed between tags of <HTML> and </HTML> is the contents 14, and a part interposed between tags of <HEAD>and </HEAD> is a name of the contents 14, and a part interposed between tags of <BODY> and </BODY> is a main body part of the contents 14,

In the browser 2, the HTML data (the above-described main body part) of the contents 14 read from the HTTP server 11 is analyzed, and if the exclusive tag Is found in the analysis, in other words, if ┌<exclusive tag SRC=“gaiyou. adpcm” hinf1=“computer” hinf2=“music”hinf3=“mp3” hinfdate=“2000/10/26”>┘ is found, an operation below will be conducted.

The browser 2 conducts a demand of the voice data for explaining the outline of the contents, which in specified by an SRC attribute, and downloads a voice file from the HTTP server 11. Successively, the browser 2 reads out the details of the information (hinf1 -hinf3) for a wide use, and conducts a regeneration demand of the common voice data in accordance with the details.

Also, the browser 2 conducts a regeneration demand of the downloaded voice data for explaining the outline, and reads out updated date and hour (hdate), and in accordance with the details thereof, conducts a regeneration demand of the updated date and hour. By means of the above-described procedure, the information for a wide use, the downloaded data and the updated date and hour are regenerated.

A voice sample in case of regenerating the above-described exclusive tag example will be shown below. A part of the information for a wide use is that “This homepage is a page related to a computer, music and mp3 (mp three). Next, please listen to the explanation by a person who has made the homepage.”, and a downloaded part is that “This homepage deals with a method how to make an mp3 (mp three) file and detailed information in relation to a copyright. Also, since there Is a notice board for information exchange, please utilize it.”, and a part of the updated date and hour is that “a final updated date is Oct. 26, 2000.”

In this manner, since the user can look at the contents 14 after confirming the outline of the contents 14 by means of voice, it is possible to inspect the contents 14 smoothly. Also, since the outline of the contents 14 can be heard by means of voice, a user who is not familiar with an internet becomes Intimate with it easily.

Further, by downloading the outline of the contents 14 as the voice data 15 and regenerating it, it is possible to remove the explanation of the outline by means of letters from the contents 14, and thereby, the contents 14 are easy to be seen and easy to be understood.

Furthermore, by loading the information for a wide use, such as a genre and updated date and hour, in the internet terminal apparatus in advance as the common voice data, it is possible to reduce information content to be downloaded.

As explained above, in accordance with the present invention, in the contents inspecting system for inspecting the contents accumulated in the server and consisting of at least the HTML data using the terminal apparatus, by storing in the server the contents in which the voice data for explaining the outline of the contents and the exclusive tag for specifying the voice data are described, and downloading the voice data corresponding to the exclusive tag in the terminal apparatus from the server, and regenerating and outputting it when it is determined that the exclusive tag exists in the contents read out from the server, there is an effect that it is possible to understand the outline of the contents easily, and it is possible to inspect the contents smoothly.

What is claimed is:

1. A contents inspecting system for inspecting contents accumulated in a server and consisting of at least IITML (hypertext markup language) data by means of a terminal apparatus, comprising:
server having storage means for storing contents in which a voice data for explaining an outline of said contents, and an exclusive tag for specifying said voice data are described, and
terminal apparatus having;
determination means for determining whether or not said exclusive tag in the contents read from said server exists,
means for downloading a voice data corresponding to said exclusive tag from said server when it is determined in said determination means that said exclusive tag exists, and;
means for regenerating and outputting said voice data in response to said exclusive tag during regeneration of said contents.

2. A contents inspecting system recited in claim 1, characterized in that only a part of the voice data, which depends on said contents, is downloaded from said server, and other information for a wide use is loaded in said terminal apparatus in advance as a common voice data.

3. A contents inspecting system recited in claim 2, characterized in that the system includes means for accumulating said downloaded voice data and means for accumulating said common voice data in advance.

4. A contents inspecting method of inspecting contents accumulated in a server and consisting of at least HTML (hypertext markup language) data by means of a terminal apparatus, characterized in that
contents in which a voice data for explaining an outline of said contents, and an exclusive tag for specifying said voice data are described, are stored in said server, and
said terminal apparatus has steps of determining whether or not said exclusive tag in the contents read from said server exists, downloading a voice data corresponding to said exclusive tag from said server when it is determined that said exclusive tag exists, and regenerating and outputting said voice data in response to said exclusive tag during regeneration of said contents.

5. A contents inspecting method recited in claim 4, characterized in that only a part of the voice data, which depends on said contents, is downloaded from said server, and other information for a wide use is loaded in said terminal apparatus in advance as a common voice data.

6. A contents inspecting method recited in claim 5, characterized in that said downloaded voice data is accumulated in first accumulation means and said common voice data is accumulated in second accumulation means in advance.
